(19) United States
(12) Patent Application Publication
(10) Pub. No.: US 2003/0125459 A1
(43) Pub. Date: Jul. 3, 2003

(54) Aqueous polymer dispersions, their preparation and use

(75) Inventors: Dirk Wulff, Schifferstadt (DE); Alexander Centner, Neustadt (DE); Gerhard Auchter, Bad Duerkheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Akiengesellschaft, Ludwigshafen (DE)

(21) Appl. No.: 10/316,914

(22) Filed: Dec. 12, 2002

(30) Foreign Application Priority Data
Dec. 27, 2001 (DE) 10164183.4
Mar. 6, 2002 (DE) 10209817.4

(51) Int. Cl. C08K 3/00; C08K 3/20

(52) U.S. Cl. 524/800; 524/457

(57) ABSTRACT

Described is a process for preparing aqueous polymer dispersions by at least two-stage free-radical aqueous emulsion polymerization of ethylenically unsaturated monomers, comprising:

1. a first polymerization stage, 1, in which a first monomer composition M(1) is polymerized in accordance with a monomer feed technique by adding a free-radical polymerization initiator I(1), giving an aqueous dispersion of a polymer P(1), and

2. a further polymerization stage, 2, in which

2a. a monomer composition M(2) whose makeup is different than that of the monomer composition M(1) is added in undiluted form to the aqueous dispersion of the polymer P(1), and

2b. the monomer composition M(2) is polymerized, and

3. if desired, steps 2a and 2b are repeated to carry out further polymerization stages, i,

the total amounts of the monomer M(2) making up from 0.1 to 20% by weight of the monomers M(1) polymerized in stage 1 and the addition of the monomer mixture M(2) not taking place before the end of the addition of the monomer mixture M(1), wherein the polymerization in polymerization stage 2 and any further polymerization stages takes place in the presence of residual amounts of the initiator I(1) added in the 1^{st} stage or by adding further initiator I(1) and from the beginning of step 1 to the end of step 2b in the last polymerization stage the temperature in the reaction vessel is at least 70° C.,

and also the use of these polymer dispersions for preparing pressure sensitive adhesives.

The present invention relates to a process for preparing aqueous polymer dispersions, to the polymer dispersions obtainable by the process, and to their use, particularly for preparing pressure sensitive adhesives.

Aqueous polymer dispersions find diverse application, for example, as coating compositions or as impregnants for paper or leather, as binders in emulsion paints, troweling compounds or synthetic resin bound plasters, for example, as modifiers for binding mineral building materials, and as adhesives or adhesive base materials.

In a variety of instances in the prior art, polymer dispersions have been proposed in which the polymer particles comprise at least two different polymer phases. Such polymer dispersions are generally prepared by initially preparing a first aqueous polymer dispersion (1^{st} stage) and in the resultant aqueous polymer dispersion conducting an emulsion polymerization of substantially hydrophobic monomers (2^{nd} stage). This 2nd stage may also be followed by further stages (stages i). This procedure is referred to as staged polymerization.

Staged polymerization produces aqueous polymer dispersions in which the polymer particles comprise predominantly both the polymer of the first polymerization stage and the polymer of the second and/or further polymerization stage(s). Aqueous polymer dispersions whose polymer particles comprise two different polymers generally have different performance properties and mixtures of two dispersions each containing one or the other kind of polymer. Staged polymerization is therefore often used to modify the performance properties of aqueous polymer dispersions.

One particular variant of the modification of aqueous polymer dispersions by staged polymerization is described in WO 98/10001. There, first of all, a first aqueous polymer dispersion is prepared by conventional emulsion polymerization. Further monomers are then added to it, these being monomers which, viewed per se, are likewise able to polymerize in accordance with an emulsion polymerization. Subsequently, polymerization of the added monomers under the conditions of a chemical deodorization is triggered by adding a new initiator. After the end of the first polymerization stage, the polymerization reaction is interrupted. This is generally done by cooling the reactor to a temperature at which free-radical polymerization is no longer able to take place: for example, to about 40° C. Then the monomers of the second polymerization stage are added. When they have been added, the batch is heated to the required polymerization temperature and then the polymerization initiator needed for the polymerization of the monomers of the 2^{nd} polymerization stage is added. By this means it is ensured that the monomers of the 2^{nd} stage swell the polymer of the first stage and subsequently polymerize to completion within the polymer particles. This produces better polymer performance properties than in the case of conventionally prepared multiphase polymers. This procedure does harbor certain disadvantages. For instance, the cooling and reheating require additional energy consumption. Moreover, the cooling and reheating prolong the reaction time (cycle time), resulting ultimately in a poorer space/time yield. Moreover, it has been found that the performance properties, especially with regard to the use of the polymers as pressure sensitive adhesives, are often unsatisfactory.

It is an object of the present invention to provide a multistage free-radical aqueous emulsion polymerization process for ethylenically unsaturated monomers that overcomes the process disadvantages of the prior art without bearing the cost of reductions in the performance properties of the dispersions. The intention is also that the polymer dispersions prepared by the process will have better performance properties in the field of pressure sensitive adhesives.

We have found that this object is achieved by a multistage emulsion polymerization process wherein the polymerization of the second and any further polymerization stages is conducted in the presence of the initiator used in the 1^{st} polymerization stage and the temperature in the reaction vessel from the beginning of the 1^{st} polymerization stage to the end of the last polymerization stage is always at least 70° C.

The present invention accordingly provides a process for preparing aqueous polymer dispersions by at least two-stage free-radical aqueous emulsion polymerization of ethylenically unsaturated monomers, comprising:

1. a first polymerization stage, 1, in which a first monomer composition M(1) is polymerized in accordance with a monomer feed technique by adding a free-radical polymerization initiator I(1), giving an aqueous dispersion of a polymer P(1), and

2. a further polymerization stage, 2, in which

2a. a monomer composition M(2) whose makeup is different than that of the monomer composition M(1) is added in undiluted form to the aqueous dispersion of the polymer P(1), and

2b. the monomer composition M(2) is polymerized, and

3. if desired, steps 2a and 2b are repeated to carry out further polymerization stages, i,

the total amounts of the monomers M(2) making up from 0.1 to 20% by weight of the monomers M(1) polymerized in stage 1 and the addition of the monomer mixture M(2) not taking place before the end of the addition of the monomer mixture M(1), wherein the polymerization in polymerization stage 2 and any further polymerization stages takes place in the presence of residual amounts of the initiator I(1) added in the 1^{st} stage or by adding further initiator I(1) and from the beginning of step 1 to the end of step 2b in the last polymerization stage the temperature in the reaction vessel is at least 70° C.

Here and below, a monomer composition means the monomers to be polymerized in the respective stage together as a mixture, where appropriate, with polymerization-active compounds such as regulators.

In accordance with the invention, the addition of the monomer mixture M(2) to be polymerized in the second polymerization stage takes place not before the end of the addition of the monomer mixture M(1). Similar comments apply to any subsequent polymerization stages i in respect of the respective preceding polymerization stage i-1, the serial number i standing for the respective number of the polymerization stage. The time interval between the end of the addition of the monomers M(1) and the beginning of the addition of the monomers M(2) is preferably at least 5 min, more preferably at least 10 min, and in particular at least 15 min. In general this time interval will not exceed a duration of 1.5 h, preferably 1 h, and in particular 45 min.

Before the addition of the monomers M(2), the polymerization of the 1^{st} polymerization stage is preferably taken to a point where the conversion of the monomers M(1) polymerized in the first polymerization stage is at least 95% and in particular at least 98%. The conversion of the monomers M(1) in the 1^{st} stage at time t may be determined in a manner known per se: for example, by stopping the polymerization in a sample using a stopper or by monitoring the heat changes of the polymerization reaction. Suitable stoppers include the customary polymerization inhibitors, such as hydroquinone or phenothiazine, which are normally used in the form of solutions, in alcohols for example.

The monomers M(2) are added in undiluted or neat form; i.e., not in the form of aqueous emulsion and not in the form of a solution. By neat form is meant the customary monomer qualities as normally possessed by the monomers used in an emulsion polymerization. The monomers M(2) should be added as quickly as possible in a time which depending on the amount of monomers supplied will be generally not more than one hour, preferably not more than 30 min, and in particular not more than 15 min. Without wishing to be tied to any one theory, it is assumed that by this means the polymer of the 1^{st} polymerization stage is swollen by the monomers M(2) before the monomers M(2) have polymerized in the 2^{nd} polymerization stage.

In accordance with the invention, the polymerization of the monomer mixture M(2) in the second polymerization stage is initiated by the initiator I(1) used in the first stage. The procedure for this is generally such that the addition of the initiator I(1) in the 1^{st} polymerization stage is not ended before all of the monomers M(1) have been introduced into the polymerization vessel under polymerization conditions, i.e., at above 70° C. It is also possible, however, to continue the addition of the initiator I(1) beyond this point—for example, up to the beginning or up to the end of the addition of the monomers M(2) and, where appropriate, M(i)—or else further beyond. Also possible of course is a procedure in which the addition of the initiator is interrupted with or after the end of the addition of M(1) and then the addition of the initiator I(1) is resumed. In one preferred embodiment the addition of I(1) is ended no earlier than at the end of the addition of the monomers M(1) and no later than before adding the monomers M(2), e.g., no later than 30 min and especially no later than 15 min after the end of the addition of the monomers M(1). In another embodiment the addition of the initiator is interrupted with or no later than 15 min after the end of the addition of the monomers M(1). The addition of initiator is then resumed after a brief interruption, for example, with the beginning or at the end of the addition of the monomers M(2) or inbetween. In a further embodiment the initiator I(1) is added beyond the time of the end of the addition of M(1) up to the end of the addition of the monomers M(2) and, where appropriate, M(i). In contrast to other, prior art processes, however, there is no need to add a further initiator after the addition of the monomers M(2).

In accordance with the invention all polymerization steps are conducted at temperatures of at least 70° C, preferably at least 75° C., and in particular at least 80° C.

Suitable polymerization initiators I(1) include in principle all initiators which are able to trigger a controlled free-radical emulsion polymerization at temperatures above 70° C. These include inorganic peroxides, especially peroxodisulfates, such as alkali metal and ammonium peroxodisulfates, e.g., sodium peroxodisulfate, and also organic peroxides and hydroperoxides such as tert-butyl peroxide, cumene hydroperoxide, pinane hydroperoxide, diisopropylphenyl hydroperoxide, dibenzoyl peroxide, dilauroyl peroxide, and diacetyl peroxide. Also suitable are what are known as redox initiator systems, comprising not only an organic peroxide and/or hydroperoxide but also a component which has a reductive action. Suitable components having a reductive action include, in particular, alkali metal sulfites, ascorbic acid, acetone bisulfite adduct, and the alkali metal salts of hydroxymethanesulfinic acid.

The inorganic peroxides, especially the peroxodisulfates, are used in particular as initiator systems I(1). The amount of the respective initiator, based on the monomers polymerized in each case in one polymerization stage, depends familiarly on the nature of the initiator and on the nature of the monomers polymerized. It is normally in the range from 0.1 to 2% by weight and in particular in the range from 0.2 to 1% by weight, based on the total amount of the monomers polymerized in all polymerization stages.

As compared with the prior art processes, e.g., those of WO 98/10001, the process of the invention is notable for the fact that cooling of the reaction mixture following preparation of the polymer P1 and before addition of the monomers M(2) is unnecessary. This improves the overall energy profile of the process, shortens the cycle times, and raises the space/time yield. Moreover, the addition of an initiator other than I(1) to initiate the polymerization of the monomers M(2) is, surprisingly, unnecessary.

The process of the invention is suitable in principle for preparing any of a very wide variety of multiphase emulsion polymers, the fraction of the monomers M(2) and, where appropriate, M(i) polymerized in the second and subsequent polymerization stages being not more than 20% by weight, preferably not more than 15% by weight, and in particular not more than 10% by weight of the monomers M(1) polymerized in polymerization stage 1. In general the total amount of all monomers [M(2)+ΣM(i)] is from 0.1 to 20% by weight, preferably from 0.5 to 15% by weight, and in particular from 1 to 10% by weight, based on the amount of the monomers M(1).

It is self-evident that in order to achieve a modification the monomer mixture M(1) used in the first polymerization stage and the monomer mixtures M(2) and, where appropriate, M(i) polymerized in the second and any further polymerization stages are different from one another. These differences are generally manifested in physical parameters such as glass transition temperature, hydrophilicity or swellability. The process of the invention is used preferably for preparing polymers whose polymer phases have different glass transition temperatures, the polymers P(2) prepared in the second polymerization stage preferably having a higher glass transition temperature than the polymers P(1) prepared in the first polymerization stage.

In this context it frequently proves useful to estimate the glass transition temperature, T_{g}, of the dispersed polymer on the basis of its monomer composition. According to Fox (T. G. Fox, Bull. Am. Phys. Soc. (Ser. II) 1, 123 [1956] and Ullmanns Enzyklopadie der technischen Chemie, Weinheim (1980), p. 17, 18) the glass transition temperature of copolymers at high molar masses is given in good approximation by

$$\frac{1}{{T}_{g}} = \frac{{X}^{1}}{{T}_{g}^{1}} + \frac{{X}^{2}}{{T}_{g}^{2}} + ⋯ \frac{{X}^{n}}{{T}_{g}^{n}}$$

where X¹, X², . . . , Xⁿ are the mass fractions of the monomers 1, 2, . . . , n and T_{g}¹, T_{g}², . . . , T_{g}ⁿ are the glass transition temperatures of the homopolymers of the monomers 1, 2, . . . , n, in degrees Kelvin. The homopolymer T_{g}^{s} are known, for example, from Ullmann's Encyclopedia of Industrial Chemistry, VCH, Weinheim, Vol. A 21 (1992) p. 169 or from J. Brandrup, E. H. Immergut, Polymer Handbook 3^{rd} ed, J. Wiley, New York 1989.

In general the procedure adopted for the preparation will comprise in the first polymerization stage preparing a polymer P(1) having a glass transition temperature T_{g}¹ and choosing the monomer mixture M(2) and, where appropriate, M(i) such that it corresponds (calculated in accordance with Fox) to a polymer P(2) and, where appropriate, P(i) having a theoretical glass transition temperature T_{g}² and, where appropriate, T_{g}ⁱ which is at least 10 kelvins, preferably at least 20 kelvins, and in particular at least 40 kelvins above T_{g}¹.

One preferred embodiment of the process of the invention relates to preparing emulsion polymers which can be used as adhesives or as an adhesive component in pressure sensitive adhesives. In accordance with the invention, preference here is given to emulsion polymers wherein the polymer P(1) has a glass transition temperature T_{g}¹ of not more than 0° C., preferably not more than −10° C., and with particular preference in the range from −20° C. to −60° C. Accordingly, a composition of the monomer mixture M(1) used in the first polymerization stage will be chosen such that it corresponds to a polymer P(1) having the abovementioned glass transition temperatures T_{g}¹. The monomer mixture M(2) and, where appropriate, M(i) is preferably chosen such that the theoretical glass transition temperature T_{g}² and, where appropriate, T_{g}ⁱ corresponding to the monomer composition is at least 0° C., preferably at least 5° C., and in particular at least 10° C. In one embodiment of the invention T_{g}² and, where appropriate, T_{g}ⁱ are in the range from 10° C. to 40° C. In another embodiment T_{g}² and, where appropriate, T_{g}ⁱ are above 40° C.

Where the emulsion polymers are to be used as binders for solvent-free emulsion paints, the composition of the monomer mixture M(1) will generally be chosen so as to give a polymer P(1) whose glass transition temperature T_{g}¹ is in the range from −20 to +300C and preferably in the range from −10 to +150C. The glass transition temperatures Tg² and, where appropriate, T_{g}ⁱ are preferably at least 40° C., in particular at least 60° C., and with particular preference at least 80° C.

Regarding the nature of the monomers to be polymerized there are in principle no restrictions whatsoever. Suitable in principle are all monomers and monomer mixtures which can be polymerized by the method of a free-radical aqueous emulsion polymerization. Normally, therefore, both the monomer mixture M(1) and the monomers M(2) of the second polymerization stage and, where appropriate, the monomers M(i) of the further polymerization stages i comprise at least 80% by weight and preferably at least 90% by weight, based in each case on the respective monomer mixture, of monoethylenically unsaturated hydrophobic monomers or hydrophobic monomers with conjugated diethylenic unsaturation, the term “hydrophobic monomers” relating to monomers having a water solubility of not more than 30 g/l (at 25° C. and 1 bar). Typical hydrophobic monomers are selected from vinylaromatic monomers such as styrene, α-methylstyrene, ortho-chlorostyrene or vinyltoluenes, vinyl esters of C₁-C₁₈, preferably C₁-C₁₂, monocarboxylic acids, such as vinyl acetate, vinyl propionate, vinyl butyrate, vinyl valerate, vinyl hexanoate, vinyl 2-ethylhexanoate, vinyl decanoate, vinyl laurate, vinyl stearate, and vinyl esters of Versatic® acids (Versatic® acids are branched aliphatic carboxylic acids having from 5 to 11 carbon atoms). Further suitable hydrophobic monomers include esters of α,β-ethylenically unsaturated C₃-C₁O monocarboxylic or dicarboxylic acids with C₁-C₂₀, preferably C₁-C₁₂, and especially C₁-C₈ alkanols or C₅-C₈ cycloalkanols. C₁-C₂₀ alkanols are, for example, methanol, ethanol, n-propanol, i-propanol, 1-butanol, 2-butanol, isobutanol, tert-butanol, n-hexanol, 2-ethylhexanol, n-decanol, lauryl alcohol, and stearyl alcohol. Suitable cycloalkanols are, for example, cyclopentanol and cyclohexanol. Examples of monomers of this kind are the alkyl acrylates and the alkyl methacrylates such as ethyl acrylate, isopropyl acrylate, n-butyl acrylate, isobutyl acrylate, 1-hexyl acrylate, tert-butyl acrylate, 2-ethylhexyl acrylate, 2-lauryl acrylate, 2-stearyl acrylate, methyl methacrylate, ethyl methacrylate, isopropyl methacrylate, n-butyl methacrylate, isobutyl methacrylate, 1-hexyl methacrylate, tert-butyl methacrylate, 2-ethylhexyl methacrylate, 2-lauryl methacrylate, 2-stearyl methacrylate, and the dialkyl esters of maleic acid, itaconic acid or fumaric acid, such as dimethyl maleate, di-n-butyl maleate, and di-n-butyl fumarate. Suitable hydrophobic monomers also include conjugated dienes having preferably from 4 to 10 carbon atoms, such as 1,3-butadiene, isoprene or chloroprene, olefins having preferably from 2 to 6 carbon atoms, such as ethylene, propylene, 1-butene, and isobutene, or vinyl chloride.

Besides the abovementioned monoethylenically unsaturated hydrophobic monomers the monomers to be polymerized in the individual polymerization stages may also comprise one or more comonomers different than these monomers. The fraction of the comonomers, based on the monomers to be polymerized in each case in one polymerization stage, will generally not exceed 20% by weight and preferably 10% by weight. In the monomer mixture M(1) the fraction of the comonomers is generally in the range from 0.1 to 20% by weight, preferably in the range from 0.2 to 10% by weight. The fraction of comonomers in the second and subsequent polymerization stages is generally not more than 10% by weight and in particular not more than 5% by weight, based on the monomers M(2) and, where appropriate, M(i) to be polymerized in said polymerization stage(s). In one particularly preferred embodiment the monomers M(2) and M(i) comprise exclusively or almost exclusively (i.e., ≧99.9% by weight) monoethylenically unsaturated hydrophobic monomers of the aforementioned kind.

Suitable comonomers include in principle all monoethylenically and polyethylenically unsaturated monomers which can be copolymerized with the hydrophobic monomers under the conditions of the free-radical aqueous emulsion polymerization. Monomers of this kind are known in principle to the skilled worker and comprise:

monoethylenically unsaturated monomers of limited solubility in water (solubility in the range from 30 to 150 g/l at 25° C. and 1 bar) such as methyl acrylate, acrylonitrile, and methacrylonitrile. The fraction of such monomers may be up to 20% by weight and preferably up to 10% by weight, based on the monomers to be polymerized in the polymerization stage;

monoethylenically unsaturated neutral monomers having a water solubility of more than 150 g/l (at 250C and 1 bar), examples being amides of monoethylenically unsaturated carboxylic acids such as acrylamide, methacrylamide, C₂-C₄ hydroxyalkyl esters of monoethylenically unsaturated carboxylic acids such as 2-hydroxyethyl acrylate, 2-hydroxyethyl methacrylate, 2- and 3-hydroxypropyl (meth)acrylate, and 4-hydroxybutyl (meth)acrylate, esters of monoethylenically unsaturated carboxylic acid with oligoalkylene and polyalkylene glycols or with monoalkyl ethers of oligoalkylene and polyalkylene glycols having degrees of alkoxylation in the range, for example, of from 2 to 200, e.g., methylpolyethylene glycol acrylate and methylpolyethylene glycol methacrylate having degrees of alkoxylation in the range, for example, of from 2 to 100. The fraction of such monomers is generally not more than 10% by weight and in particular not more than 5% by weight;

monoethylenically unsaturated monomers containing at least one acid group, examples being monoethylenically unsaturated carboxylic acids such as acrylic acid, methacrylic acid, vinylacetic acid, crotonic acid, and itaconic acid, monoethylenically unsaturated sulfonic acids such as vinylsulfonic and allylsulfonic acid, acryloyloxyethylsulfonic acid, 2-acrylamido-2-methylpropanesulfonic acid, monoethylenically unsaturated phosphonic acids such as vinylphosphonic acid, allylphosphonic and methallylphosphonic acid, and 2-acrylamido-2-methylpropanephosphonic acid, and also the salts of the aforementioned monoethylenically unsaturated acids, preferably the alkali metal salts and the ammonium salts. The fraction of such monomers will generally be not more than 5% by weight and in the case of the monomers M(1) is preferably in the range from 0.1 to 5% by weight and in particular in the range from 0.1 to 2% by weight, based on the monomers M(1). The monomers M(2) and, where appropriate, M(i) preferably contain none or not more than 1% by weight, preferably not more than 0.1% by weight, of the abovementoined monomers containing an acid function.

diethylenically or polyethylenically unsaturated monomers which lead to crosslinking during the polymerization. These are generally monomers which have two nonconjugated, ethylenically unsaturated bonds, examples being the diesters of dihydric alcohols with α,β-monoethylenically unsaturated C₃-C₈ monocarboxylic acids, such as glycol bisacrylate, propanediol bisacrylate, butanediol bisacrylate, hexanediol bisacrylate, diethylene glycol bisacrylate, and triethylene glycol bisacrylate, and the corresponding methacrylates as well, esters of the α,β-unsaturated monocarboxylic acids with alkenols such as bicyclodecenyl (meth)acrylate, and also divinylbenzene, N,N′-divinylurea, N,N′-divinylimidazolidone, diallyl phthalate, and the like. The fraction of such monomers as a proportion of the monomers M(1) to be polymerized in the 1^{st} polymerization stage is preferably not more than 5% by weight. In one preferred embodiment of the process of the invention the monomer mixture M(1) contains none or not more than 0.1% by weight, in particular not more than 0.01% by weight, of such monomers, based on the monomer mixture M(1). The fraction of such monomers in the monomer mixture M(2) and, where appropriate, M(i) will generally not be more than 1% by weight, based on the respective monomer mixture. In one preferred embodiment of the process of the invention the monomer mixtures M(2) and, where appropriate, M(i) contain none or not more than 0.1% by weight, in particular not more than 0.01% by weight, of such monomers.

The process of the invention is especially suitable for preparing emulsion polymers whose polymer phase P(1) is composed substantially of a mixture of at least one C₂-C₂₀ alkyl acrylate and at least one further monomer selected from methyl acrylate, C₁-C₄ alkyl methacrylates, vinylaromatic monomers, acrylonitrile, and methacrylonitrile. Accordingly, in one preferred embodiment of the process of the invention, the monomer mixture M(1) comprises from 90 to 99% by weight and in particular from 95 to 99.9% by weight of a monomer mixture composed of at least one C₂-C₂₀ alkyl acrylate, preferably a C₂-C₁₀ alkyl acrylate, selected with particular preference from ethyl acrylate, n-butyl acrylate, isobutyl acrylate, and 2-ethylhexyl acrylate, and at least one further monomer selected from methyl acrylate, C₁-C₄ alkyl methacrylates, especially methyl methacrylate and tert-butyl methacrylate, vinylaromatic monomers, especially styrene, acrylonitrile, and methacrylonitrile.

Where the polymers obtainable by the process of the invention are used in adhesives, including pressure sensitive adhesives, the fraction of C₁-C₂₀ alkyl acrylates, based on the total amount of the monomer mixture M(1a), is from 50 to 99% by weight and in particular from 70 to 90% by weight. Accordingly, the fraction of the other monomers is from 1 to 50% by weight and in particular from 5 to 30% by weight.

Besides the monomers M(1a), the monomer mixture M(1) of course also contains from 0.1 to 10% by weight and preferably from 0.5 to 5% by weight of the aforementioned comonomers, preferably monomers containing an acid group and/or neutral monomers, which have a solubility in water of more than 150 g/l.

Generally at least 90% by weight and in particular at least 99% by weight and with particular preference at least 99.9% by weight of the monomer mixture M(2) is composed of monoethylenically unsaturated, hydrophobic monomers, particularly of those hydrophobic monomers whose homopolymers have a glass transition temperature of more than 20° C., preferably more than 30° C., and in particular more than 50° C. These include, in particular, C₁-C₄ alkyl methacrylates such as methyl methacrylate, tert-butyl acrylate, vinylaromatic monomers such as styrene, and the like. Preference is also given to mixtures comprising 99% by weight and in particular 99.9% by weight of at least two different hydrophobic, monoethylenically unsaturated monomers whose homopolymers have different glass transition temperatures, the theoretical glass transition temperature of the mixture being generally 0° C., preferably at least 5° C., and in particular at least 10° C. These include mixtures of from 10 to 90% by weight, especially from 20 to 80% by weight, of at least one hydrophobic, monoethylenically unsaturated monomer having a corresponding glass transition temperature of below 10° C., especially below −5° C., a C₂-C₁₀ alkyl acrylate for example, and from 10 to 90% by weight, especially from 20 to 80% by weight, of at least one hydrophobic, monoethylenically unsaturated monomer having a corresponding glass transition temperature of more than 20° C., especially more than 30° C., and very especially more than 50° C., a C₁-C₄ alkyl methacrylate, tert-butyl acrylate or a vinylaromatic monomer, for example.

The emulsion polymer of the 1^{st} polymerization stage is prepared conventionally by the method of a free-radical aqueous emulsion polymerization in accordance with a monomer feed technique. A monomer feed technique is understood as meaning that the major amount, preferably at least 80% by weight, in particular at least 90% by weight, and with particular preference all, or virtually all, of the monomers M(1) is supplied to the polymerization reaction during its course. In other words, the monomers M(1) are generally added over a prolonged period, amounting for example from 0.5 h to 10 h or preferably from 1 h to 5 h. In principle, however, longer or shorter addition times are possible. The addition may be made either at intervals or else—preferably—continuously, it being possible to change—for example, raise or lower—the rate of addition in the course of the addition (referred to as a gradient regime). The composition of the monomer mixture M(1) may be changed or kept constant in terms of the monomer constituents and of other additives such as emulsifiers and, where appropriate, regulators during their addition. The monomers M(1) may be added either in the form of an aqueous emulsion or in neat form, the former procedure being preferred. Where the monomers M(1) are added in the form of an aqueous emulsion, said emulsion generally comprises at least one surface-active substance, preferably at least one emulsifier, for the purpose of stabilizing the monomer emulsion. The concentration of the monomers in this emulsion is generally in the range from 30 to 90% by weight and preferably in the range from 50 to 80% by weight.

The addition of the initiator I(1) triggering the polymerization of the monomers M(1) in the first polymerization stage takes place in a manner known per se, usually involving the addition of the major amount of the initiator, in particular at least 90% of the total amount of the initiator I(1), to the polymerization reaction in parallel with the addition of the monomers M(1). The beginning and end of addition of initiator need not necessarily coincide with the beginning and end of the addition of the monomers M(1). In many cases a procedure will be adopted in which a portion of the initiator, from 1 to 20% by weight for example, preferably from 2 to 10% by weight, is introduced into the polymerization vessel before the beginning of the addition of the monomers M(1) and only then is the addition of the monomers M(1) commenced. In the first polymerization stage the addition of initiator is generally not ended before the ending of the addition of the monomers, or else is continued beyond it in the manner described above. The rate of addition of initiator in the course of the first polymerization stage may be altered or kept constant. The rate of addition of initiator is guided in a manner known per se by the nature and rate of addition of the monomers M(1) and by features of the reaction vessel apparatus. The initiator is normally added in diluted form, preferably in the form of an aqueous solution or suspension, with the initiator concentration normally being in the range from 1 to 20 g/l and in particular from 1 to 15 g/l.

Where the polymer dispersions of the invention are to be employed as adhesives or in adhesive formulations, it has proven advantageous to conduct the polymerization of the monomer mixture M(1) and, where appropriate, of the monomer mixture M(2) in the presence of at least one molecular weight regulator. In the second polymerization stage, preferably no regulator is added. Typical regulator amounts are in the range from 0.01 to 1% by weight, in particular from 0.02 to 0.3% by weight, based on 100% by weight of the total monomers polymerized. The amount of regulator may be the same in every polymerization stage or may differ from one stage to another. Typical molecular weight regulators are organic sulfur compounds, halogenated hydrocarbons, silanes, allyl alcohols, and aldehydes. Molecular weight regulators preferred in accordance with the invention are compounds containing at least one thiol group such as thioglycolic acid, ethyl thioglycolate, mercaptoethanol, mercaptopropyltrimethoxysilane, and linear or branched alkyl mercaptans such as tert-butyl mercaptan and tert-dodecyl mercaptan. The addition of the regulator to the polymerization vessel takes place preferably continuously during the polymerization of the respective monomer mixture. Preferably, both the major amount of the monomers to be polymerized and the major amount of the molecular weight regulator are supplied continuously to the polymerization reaction. The molecular weight regulator is preferably supplied as a separate, preferably aqueous, solution or is supplied together with the monomers, e.g. in an aqueous monomer emulsion, continuously to the polymerization reaction.

Surface-active substances suitable for conducting the emulsion polymerization are the emulsifiers and protective colloids that are normally used for these purposes. The surface-active substances are normally used in amounts of up to 10% by weight, preferably from 0.1 to 5% by weight, and in particular from 0.5 to 4% by weight, based on the monomers M(1) to be polymerized in the first stage.

Examples of suitable protective colloids are polyvinyl alcohols, starch derivatives and cellulose derivatives, or vinylpyrrolidone copolymers. A detailed description of further suitable protective colloids is given in Houben-Weyl, Methoden der organischen Chemie, Volume XIV/1, Makromolekulare Stoffe, Georg-Thieme-Verlag, Stuttgart 1961, pp. 411-420. Mixtures of emulsifiers and/or protective colloids can also be used. As surface-active substances it is preferred to use exclusively emulsifiers, whose relative molecular weights, unlike those of the protective colloids, are normally below 2000. It is preferred to use at least one anionic emulsifier, in combination where appropriate with a nonionic emulsifier.

The anionic emulsifers include alkali metal salts and ammonium salts of alkyl sulfates (alkyl radical: C₈-C₁₂), of dialkyl esters with sulfosuccinic acid (alkyl radical: C₄-C₁O), of sulfuric monoesters with ethoxylated alkanols (EO units: 2 to 50, alkyl radical: C₁₂ to C₁₈) and with ethoxylated alkylphenols (EO units: 3 to 50, alkyl radical: C₄-C₁₀), of alkylsulfonic acids (alkyl radical: C₁₂-Cl₈) and of alkylarylsulfonic acids (alkyl radical: C₉ to C₁₈). The anionic surface-active substances also include monoalkyl and dialkyl derivatives of sulfonylphenoxybenzenesulfonic salts, especially their sodium, potassium or calcium salts. The alkyl groups in these compounds generally have 6 to 18 and especially 6, 12 or 16 carbon atoms. Use is frequently made of technical-grade mixtures containing a fraction of 50 to 90% by weight of the monoalkylated product. These compounds are common knowledge, from U.S. Pat. No. 4,269,749 for example, and are available commercially, as Dowfax® 2A1 (trademark of Dow Chemical Company), for example.

Suitable nonionic emulsifiers are araliphatic or aliphatic nonionic emulsifiers, examples being ethoxylated mono-, di- and trialkylphenols (EO units: 3 to 50, alkyl radical: C₄-C₉), ethoxylates of long-chain alcohols (EO units: 3 to 50, alkyl radical: C₈-C₃₆), and also polyethylene oxide/polypropylene oxide block copolymers. Preference is given to ethoxylates with long-chain alkanols (alkyl radical: C₁₀-C₂₂, average degree of ethoxylation: from 3 to 50) and, of these, particular preference to those based on oxo alcohols and natural alcohols having a linear or branched C₁₂-C₁₈ alkyl radical and a degree of ethoxylation of from 8 to 50.

Further suitable emulsifiers can be found in Houben-Weyl, Methoden der organischen Chemie, Volume XIV/1, Makromolekulare Stoffe, Georg-Thieme-Verlag, Stuttgart, 1961, pp. 192-208.

With regard to the use of the polymer dispersions prepared by the process of the invention in adhesives and in emulsion paints, the surface-active substances used for preparing the polymer dispersions of the invention preferably include at least one anionic emulsifier. For the stability of the polymer dispersions of the invention, especially with respect to mechanical loads such as shearing forces, it has proven advantageous if the anionic emulsifiers used with preference for preparing the dispersions of the invention include at least one salt of a dialkyl ester of sulfosuccinic acid (linear or branched C₄-C₁₀ and especially C₈ alkyl, radical), preferably an alkali metal salt, and in particular the sodium salt.

The polymerization medium may consist either of water alone or of mixtures of water and water-miscible organic liquids such as methanol, ethanol, n-propanol, isopropanol, n-butanol, tert-butanol, tetrahydrofuran, formamide and dimethylformamide, the fraction of these liquids, based on the polymerization medium, being usually not more than 10% by weight, in particular not more than 5% by weight, and especially not more than 1% by weight. Preferably, water alone is used as the polymerization medium.

With regard to the use of the polymers obtainable by the process of the invention it has proven advantageous if the polymer particles have an average diameter in the range from 50 to 1000 nm (determined by means of an ultracentrifuge or by means of photon correlation spectroscopy; on particle size determination see W. Mächtle, Angew. Makromolekulare Chemie 185 (1984), 1025-1039, W. Machtle, ibid., 162 (1988) 35-42). In the case of formulations having high solids contents, e.g., >50% by weight, based on the overall weight of the formulation, it is of advantage on viscosity grounds if the weight-average diameter of the polymer particles in the dispersion is ≧100 nm. The average particle diameter will preferably not exceed 800 nm. It has also proven favorable if the diameters of the individual polymer particles vary over a wide range, especially if the size distribution has two or more maxima (polymer dispersions having a bimodal or polymodal polymer particle size distribution). Measures to adjust the polymer particle size distribution are known to the skilled worker (see, for example, EP-A 614 922 and documents cited therein).

Besides the seed-free preparation mode, in order to set a defined polymer particle size it is possible to carry out the emulsion polymerization of the 1^{st} polymerization stage by the seed latex method or in the presence of seed latex produced in situ. Methods of doing this are known and may be found in the prior art (see EP-B 40 419, EP-A-614 922, EP-A-567 812 and literature cited therein, and also ‘Encyclopedia of Polymer Science and Technology’, Vol. 5, John Wiley & Sons Inc., New York 1966, p. 847).

In the case of the seed latex method the 1^{st} polymerization stage is normally conducted in the presence of from 0.001 to 3% by weight and in particular from 0.01 to 1% by weight of a seed latex (solids content of the seed latex, based on total monomer amount), preferably with seed latex introduced initially (initial charge seed). The latex generally has a weight-average particle size of from 10 to 200 nm and in particular from 20 to 200 nm. Its constituent monomers are generally monomers M(2), examples being styrene, methyl methacrylate, n-butyl acrylate, and mixtures thereof, it being possible for the seed latex to contain in copolymerized form to a minor extent monomers M(1) and/or M(3) as well, preferably less than 10% by weight, based on the total weight of the polymer particles in the seed latex.

Following the last polymerization stage, for the purpose of removing the residual monomers, it is normal to conduct a deodorization by physical means, e.g., by distillative removal of the volatile monomers with steam, or by chemical means. In the case of chemical deodorization further initiator, e.g., a redox initiator, is added after the end of the emulsion polymerization proper, i.e., after a conversion of the monomers M(2) and, where appropriate, M(i) of at least 95%. Deodorization is carried out preferably no earlier than 10 min and especially no earlier than 20 min after the end of the addition of M(2) and, where appropriate, M(i) to the last polymerization stage. Redox initiators suitable for chemical deodorization include as their oxidizing component, for example, at least one organic peroxide and/or hydroperoxide such as tert-butyl peroxide, cumene hydroperoxide, pinane hydroperoxide, diisopropylphenyl hydroperoxide, dibenzoyl peroxide, dilauryol peroxide, and diacetyl peroxide, and as their reductive component, for example, alkali metal sulfites, ascorbic acid, acetone bisulfite adduct and/or an alkali metal salt of hydroxymethanesulfinic acid. Where appropriate, physical deodorization may accompany or follow the chemical deodorization. It is likewise possible first to carry out physical deodorization and then the chemical deodorization.

The solids content of the polymer dispersions obtained by the process of the invention is generally at least 30% by weight, preferably at least 40% by weight, and in particular at least 50% by weight. It may be up to 75% by weight and with particular preference is situated in the range from 50 to 65% by weight.

The polymer dispersions obtainable by the process of the invention are particularly suitable as adhesives and as an adhesive component, i.e., as an adhesive base material, for adhesive formulations, particularly for aqueous adhesive formulations. Thus the polymer dispersions of the invention are notable for a balanced proportion between the adhesion of the adhesive to the bond substrate and the internal strength (cohesion) of the adhesive film. This profile of properties makes the polymer dispersions of the invention particularly suitable as pressure sensitive adhesives or as adhesive base materials for pressure sensitive adhesives. The present invention accordingly further provides for the use of the aqueous polymer dispersions of the invention as adhesives and adhesive base materials, especially as pressure sensitive adhesives.

The polymer dispersions of the invention may be used as they are or after being formulated with customary auxiliaries. Examples of customary auxiliaries are wetting agents, thickeners, defoamers, plasticizers, pigments, fillers, protective colloids, light stabilizers, and biocides.

In the case of use as pressure sensitive adhesives, tackifiers, i.e., tackifying resins, may also be added to the polymer dispersions of the invention as auxiliaries. Tackifiers are known, for example, from Adhesive Age July 1987, pp. 19-23, or Polym. mater. Sci. Eng. 61 (1989) 588 to 592. Examples of tackifiers are resins and their derivatives. The resins may be used, for example, in their salt form or, preferably, in esterified form. Further examples of tackifiers are hydrocarbon resins, such as coumarone resins, polyterpene resins, indene resins, and hydrocarbon resins based on unsaturated hydrocarbons such as butadiene, pentene, methylbutene, isoprene, piperylene, divinylmethane, cyclopentene, cyclopentadiene, cyclohexene, cyclohexadiene, styrene or vinyltoluene. Further suitable tackifiers include low molecular mass polymers of alkyl esters of acrylic acid and/or methacrylic acid, generally with a weight-average molecular weight of below 30,000 and an alkyl (meth)acrylate content of at least 60% by weight, in particular at least 80% by weight. Preferred tackifiers are natural or chemically modified resins. They consist predominantly of abietic acid or derivatives thereof.

Where desired, the tackifiers are used in amounts up to 100% by weight, preferably from 5 to 50% by weight, based on the staged polymer of the invention, in the adhesive formulation. The feature of the dispersions of the invention is that they can be used even without tackifiers.

The polymer dispersions of the invention may also be dried to give polymer powders in accordance with known processes of the prior art.

The pressure sensitive adhesive formulations may be applied to substrates by customary methods, e.g., by rolling, knifecoating, brushing, etc. The water present in the adhesive formulation may be removed by drying at ambient temperature or elevated temperature in the range, for example, from 50 to 150° C. Besides paper and card, suitable substrates include polymer films, especially those of polyethylene, oriented polypropylene, polyamide, which may have been biaxially or monoaxially oriented, polyethylene terephthalate, polyamide, polystyrene, polyvinyl chloride, polyacetate, regenerated cellulose, polymer films (vapor-)coated with metal (e.g., with aluminum) (metalized films for short) and metal foils, made for example of aluminum. Said films and foils may also have been printed, for example, with printing inks. For the purpose of subsequent use, the side of the substrate—for example, of labels—that is coated with the pressure sensitive adhesive may be lined with a release paper, such as with siliconized paper, for example.

The following examples are intended to illustrate the invention.

I. Preparation of the Polymer Dispersions (Examples 1 and 2 (Inventive), Examples C1 and C2 (Comparative)).

### EXAMPLE 1

A polymerization reactor was charged under nitrogen with 150 g of deionized water and 1.7 g of a 33% by weight aqueous seed latex (average particle size d₅₀ 30 nm). The initial charge was heated to 95° C. and then 4 g of the initiator solution were added to the initial charge by retaining the temperature. After 5 min, the monomer feed stream and the remainder of the initiator solution were run in, beginning simultaneously, over a period of 3 h at constant feed rate. After the end of the addition of monomer and initiator the temperature was maintained for a further 15 min, then 28 g of styrene were added over the course of 15 min, and stirring was continued at 95° C. for a further 30 min. Then 16.8 g of a 10% strength by weight aqueous solution of tert-butyl hydroperoxide and 14.9 g of a 12% strength by weight solution of acetone bisulfite adduct were introduced into the polymerization vessel over the course of 30 min, beginning simultaneously. This was followed by the successive addition of 19.6 g of a 10% strength by weight sodium hydroxide solution and of 7.84 g of a 50% strength by weight solution of the sodium salt of the dioctyl ester of sulfosuccinic acid. After that the batch was cooled to room temperature.

The solids content of the resulting dispersion was 54.3% by weight. The pH was 7.4. A 0.01% by weight sample of the dispersion had a light transmittance of 50% (determined by photometry on a 0.01% by weight sample of the dispersion against water, using white light).

Monomer feedstream: Aqueous emulsion of

207.9 g of deionized water,

12.4 g of emulsifier solution 1,

3.7 g of emulsifier solution 2,

0.3 g of tert-dodecyl mercaptan,

5.0 g of acrylic acid,

289.0 g of n-butyl acrylate,

170.8 g of 2-ethylhexyl acrylate,

67.2 g of methyl methacrylate.

Initiator solution: 40 g of a 7% strength by weight aqueous solution of sodium peroxodisulfate.

Emulsifier solution 1: 45% strength by weight aqueous solution of the sodium salt of a mixture of mono- and bisdodecyl diphenyl ether disulfonic acid (Dowfax 2A1 from Dow Chemical)

Emulsifier solution 2: 30% strength by weight aqueous solution of the sodium salt of the sulfuric monoester of an ethoxylated C12 alkanol (degree of ethoxylation approximately 30).

### EXAMPLE C1

A polymerization reactor was charged under nitrogen with 150 g of deionized water and 1.7 g of a 33% by weight aqueous seed latex (average particle size d₅₀ 30 nm). The initial charge was heated to 95° C. and then 4 g of the initiator solution were added to the initial charge by retaining the temperature. After 5 min, the monomer feed stream and the remainder of the initiator solution were run in, beginning simultaneously, over a period of 3 h at constant feed rate. After the end of the addition of monomer, the temperature was maintained for 30 min, and then, beginning simultaneously and over the course of 30 min, while maintaining the temperature, 16.8 g of a 10% strength by weight aqueous solution of tert-butyl hydroperoxide and 14.9 g of a 12% strength by weight aqueous solution of acetone bisulfite adduct were added. Immediately thereafter, 19.6 g of a 10% strength by weight sodium hydroxide solution and of 7.8 g of a 50% strength by weight solution of the sodium salt of the dioctyl ester of sulfosuccinic acid were added. After that the batch was cooled to room temperature.

The solids content of the resulting dispersion was 55.3% by weight. The pH was 7.1. A 0.01% by weight sample of the dispersion had a light transmittance of 50% (determined by photometry on a 0.01% by weight sample of the dispersion against water, using white light).

Monomer feedstream: aqueous emulsion of

207.9 g of deionized water,

12.4 g of emulsifier solution 1,

3.7 g of emulsifier solution 2,

0.3 g of tert-dodecyl mercaptan,

5.0 g of acrylic acid,

289.0 g of n-butyl acrylate,

170.8 g of 2-ethylhexyl acrylate,

67.2 g of methyl methacrylate.

Initiator solution: 40 g of a 7% strength by weight aqueous solution of sodium peroxodisulfate.

### EXAMPLE 2

A polymerization reactor was charged with 270 g of deionized water and 1.8 g of a 33% by weight aqueous seed latex (as in Example 1) (average particle size d₅₀ 30 nm). This initial charge was heated to 85° C. and then 9.4 g of the initiator solution were added over the course of 2 min. After a further 2 min, the monomer feed stream and the remainder of the initiator solution were introduced into the polymerization vessel over a period of 240 min, beginning simultaneously, while maintaining at 85° C. After the end of the addition of monomer and of initiator the 85° C. were maintained for 15 min and then at 85° C. 75 g of methyl methacrylate were added in one portion, stirring was continued at 85° C. for 30 min, and immediately thereafter 55 g of deionized water and 5 g of a 10% strength by weight sodium hydroxide solution were added over the course of 60 min. Immediately thereafter, beginning simultaneously, 22.5 g of a 10% strength by weight aqueous tert-butyl hydroperoxide solution and 18.0 g of a 10% strength by weight solution of the sodium salt of hydroxymethanesulfinic acid were introduced into the polymerization vessel at 85° C. over the course of 60 min. The batch was then cooled to room temperature.

The solids content of the resulting dispersion was 60.5% by weight. The pH was 7.8. A 0.01% by weight sample of the dispersion had a light transmittance of 43% (determined by photometry on a 0.01% by weight sample of the dispersion against water, using white light).

Monomer feedstream: aqueous emulsion of

325 g of deionized water,

96.3 g of emulsifier solution 3,

75.0 g of emulsifier solution 4,

14.4 g of acrylic acid,

180.5 g of methyl methacrylate,

29.7 g of styrene,

1265.0 g of 2-ethylhexylacrylate.

Initiator solution: 8.4 g of sodium peroxodisulfate in 111.6 g of deionized water.

Emulsifier solution 3: 31% strength by weight aqueous solution of an anionic emulsifier (Emulphor®NPS from BASF AG) Emulsifier solution 4: 20% strength by weight aqueous solution of an anionic emulsifier (Emulsifier 825, BASF AG)

### EXAMPLE C2a

A polymerization reactor was charged under nitrogen with 150 g of deionized water and 1.7 g of a 33% by weight aqueous seed latex (average particle size d₅₀ 30 nm). The initial charge was heated to 95° C. and then, while maintaining the temperature, 4 g of the initiator solution were introduced into the initial charge. After 5 min, the monomer feed and the remainder of the initiator solution were added, beginning simultaneously, over a period of 3 h, at constant feed rate. After the end of the addition of monomer and initiator, 55 g of deionized water and 61.5 g of a 10% strength by weight sodium hydroxide solution were added over the course of 60 min at 85° C. Immediately thereafter, beginning simultaneously, 22.5 g of a 10% strength by weight aqueous tert-butyl hydroperoxide solution and 18.0 g of a 10% strength by weight solution of the sodium salt of hydroxymethanesulfinic acid were added over a period of 60 min at 85 C. The batch was then cooled to room temperature.

The solids content of the resulting aqueous polymer dispersion was 61.5% by weight. The pH was 7.9. A 0.01% by weight sample of the dispersion had a light transmittance of 42% (determined by photometry on a 0.01% by weight sample of the dispersion against water, using white light). The average size of the polymer particles (determined by means of photon correlation spectroscopy) was 340 nm.

Monomer feedstream: aqueous emulsion of

325 g of deionized water,

96.3 g of emulsifier solution 3,

75.0 g of emulsifier solution 4,

14.4 g of acrylic acid,

180.5 g of methyl methacrylate,

29.7 g of styrene,

1265.0 g of 2-ethylhexyl acrylate.

Initiator solution: 8.4 g of sodium peroxodisulfate in 111.6 g of deionized water.

### EXAMPLE C2b

The polymerization was carried out as for Example C2a but with the monomer feedstream having the following composition:

aqueous emulsion of

325 g of deionized water,

96.3 g of emulsifier solution 3,

75.0 g of emulsifier solution 4,

14.4 g of acrylic acid,

255.5 g of methyl methacrylate,

29.7 g of styrene,

1265.0 g of 2-ethylhexyl acrylate.

### EXAMPLE 3

The polymerization was carried out as for Example 2 but adding in the 2^{nd} polymerization stage not 75 g of methyl methacrylate but instead a mixture of 37.5 g of methyl methacrylate and 37.5 g of 2-ethylhexyl acrylate.

The solids content of the resulting dispersion was 60.5% by weight. The pH was 7.8. A 0.01% by weight sample of the dispersion had a light transmittance of 46% (determined by photometry on a 0.01% by weight sample of the dispersion against water, using white light).

II. Performance Testing

II.1 Test Methods:

a) Production of the Test Strips

The test dispersion is investigated without the addition of tackifiers. Using a doctor blade, the mixture is applied in a thin film to a siliconized paper and dried at 90° C. for 3 min. The height of the gap in the doctor blade is chosen so as to give an application rate of from 18 to 22 g/m² for the dried adhesive. Atop the dried adhesive there is placed commercially customary polypropylene film (OPP film; thickness 30 μm, corona pretreated) which is rolled on firmly using a manual roller. The film laminate thus produced is cut into strips 2.5 cm wide. Prior to testing, these strips are stored under standard conditions for at least 24 h.

b) Testing of the Peel Strength (in Accordance with FINAT FTM 1)

After the siliconized paper has been peeled off a 2.5 cm wide test strip is bonded to an Afera metal test panel and to a polyethylene test element. Ambient conditions: 23° C., 50% relative humidity. 1 minute after bonding, the strip is pulled apart at an angle of 180° with a speed of 300 mm/min using a tensile tester machine. The peel strength reported is the force needed for this, in N/2.5 cm, as the average from the results of three test specimens.

c) Testing of the Cohesion (Shear Strength in Accordance with FINAT FTM 7)

After the siliconized paper has been peeled away, the test strip is bonded to the edge of an Afera metal test panel in such a way as to give a bond area of 6.25 cm². 10 minutes after bonding, a 1000 g weight is fastened to the protruding end of the film and the metal test panel is suspended vertically. Ambient conditions: 23° C., 50% relative humidity. The shear strength reported is the time to failure of the bond under the effect of the weight, as the average from the results of three test specimens, in hours.

TABLE

| | Peel strength 300 mm/min [N/2.5 cm] | | | | | | Cohesion [h] | |
|---|---|---|---|---|---|---|---|---|
| | Afera | | Polyethylene | | | | Afera | |
| Example | immed. | FT | immed. | FT | 24 h | FT | | FT |
| 1 | 4.2 | A | 4.5 | A | 2.7 | A | 50 | C |
| C1 | 4.2 | A | 4.1 | F | 2.8 | F | 11 | C |
| 2 | 7.1 | A | 5.1 | A | 7.7 | A | 105 | F/R |
| C2a | 6.0 | A | 4.9 | F | 7.3 | F | 55 | F/C |
| C2b | 6.1 | A | 5.0 | F | 6.2 | F | 110 | F/C |
| 3 | 6.9 | A | 5.2 | A | 8.5 | A | 92 | C |

FT: fracture type
A: adhesive fraction
C: cohesive fraction
F: tack-free film on the substrate
R: pointwise residues

We claim:

1. A process for preparing aqueous polymer dispersions by at least two-stage free-radical aqueous emulsion polymerization of ethylenically unsaturated monomers, comprising:
1. a first polymerization stage, 1, in which a first monomer composition M(1) is polymerized in accordance with a monomer feed technique by adding a free-radical polymerization initiator I(1), giving an aqueous dispersion of a polymer P(1), and
2. a further polymerization stage, 2, in which
2a. a monomer composition M(2) whose makeup is different than that of the monomer composition M(1) is added in undiluted form to the aqueous dispersion of the polymer P(1), and
2b. the monomer composition M(2) is polymerized, and
3. if desired, steps 2a and 2b are repeated to carry out further polymerization stages, i,
the total amounts of the monomers M(2) making up from 0.1 to 20% by weight of the monomers M(1) polymerized in stage 1 and the addition of the monomer mixture M(2) not taking place before the end of the addition of the monomer mixture M(1), wherein the polymerization in polymerization stage 2 and any further polymerization stages takes place in the presence of residual amounts of the initiator I(1) added in the 1^{st} stage or by adding further initiator I(1) and from the beginning of step 1 to the end of step 2b in the last polymerization stage the temperature in the reaction vessel is at least 70° C.

2. The process as claimed in claim 1, wherein the time interval between the time of the ending of the addition of the monomers M(1) and/or the ending of the addition of initiator I(1) and the beginning of the addition of the monomers M(2) is at least 5 min.

3. The process as claimed in claim 1, wherein the addition of the initiator I(1) is not ended before the end of the addition of the monomers M(1).

4. The process as claimed in claim 1, wherein the monomers M(1) contain from 90 to 99.9% by weight of a monomer mixture composed of
at least one C₂-C₂₀ alkyl acrylate and
at least one further monomer selected from methyl acrylate, C₁-C₄-alkyl methacrylates, vinylaromatic monomers, acrylonitrile, and methacrylonitrile.

5. The process as claimed in claim 1, wherein the monomers M(2) and, where appropriate, M(i) used in the 2^{nd} and any further polymerization stages contain less than 0.1% by weight of monomers containing acid groups, based on the amount of M(2) and, where appropriate, M(i) used in each case.

6. The process as claimed in claim 1, wherein the monomers M(2) and, where appropriate, M(i) used in the 2^{nd} and any further polymerization stages contain none or less than 0.01% by weight of polyethylenically unsaturated monomers.

7. The process as claimed in claim 1, wherein the monomers M(2) and, where appropriate, M(i) used in the 2^{nd} and any further polymerization stages comprise exclusively monoethylenically unsaturated hydrophobic monomers having a water solubility of less than 30 g/l at 25° C. (1 bar).

8. The process as claimed in claim 1, wherein the monomers M(1) contain from 0.1 to 5% by weight, based on the amount of monomers M(1), and at least one monomer containing at least one acid group.

9. The process as claimed in claim 1, wherein the total amount of all monomers M(2) and, where appropriate, M(i) is from 1 to 10% by weight, based on the monomers M(1).

10. The process as claimed in claim 1, wherein the polymer P(1) of the first polymerization stage has a glass transition temperature T_{g}¹ and the monomer mixture M(2) and, where appropriate, M(i) polymerized in the 2^{nd} and, where appropriate, i-th polymerization stage corresponds to a polymer P(2) and, where appropriate, P(i) having a theoretical glass transition temperature T_{g}² and, where appropriate, T_{g}ⁱ (calculated by the method of Fox) which is greater by at least 10K than T_{g}¹.

11. The process as claimed in claim 10, wherein the difference between the glass transition temperatures, T_{g}²−T_{g}¹, or where appropriate T_{g}ⁱ−T_{g}¹, is at least 40 K.

12. The process as claimed in claim 1, wherein the monomer mixture M(1) used in step 1 corresponds to a polymer P(1) having a theoretical glass transition temperature T_{g}¹ (calculated by the method of Fox) of not more than 0° C.

13. An aqueous polymer dispersion obtained by a process as claimed in claim 1.

14. A polymer powder obtained by evaporating the volatile constituents from an aqueous polymer dispersion of claim 13.

15. A method for producing pressure sensitive adhesives by mixing an aqueous polymer dispersion of claim 13, or a polymer powder obtained by evaporating the volatile constituents from the polymer dispersion with customary auxiliaries for pressure sensitive adhesives.
